(19) United States
(12) Patent Application Publication
(10) Pub. No.: US 2024/0415358 A1
(43) Pub. Date: Dec. 19, 2024

(54) CONTROL METHOD, MOVABLE PLATFORM, AND STORAGE MEDIUM

(71) Applicant: SZ Shanzhi Technology Co., Ltd., Shenzhen (CN)

(72) Inventors: Ang LIU, Shenzhen (CN); Ting ZOU, Shenzhen (CN)

(21) Appl. No.: 18/821,266

(22) Filed: Aug. 30, 2024

Related U.S. Application Data
(63) Continuation of application No. PCT/CN2022/078937, filed on Mar. 3, 2022.

(51) Int. Cl. A47L 11/40

(52) U.S. Cl. CPC A47L 11/4061; A47L 11/4008; A47L 11/4011

(57) ABSTRACT

A control method includes obtaining a plurality of boundary points at a boundary of a detected region and an undetected region while a movable platform is moving indoors and performing detection on an indoor environment using a detection device, selecting a target boundary point from the plurality of boundary points according to feature information of the boundary points, and controlling the movable platform to move. For each of the boundary points, the feature information includes semantic information of at least a part of a region to be passed by the movable platform when moving from a current position to the boundary points.

### CROSS-REFERENCE TO RELATED APPLICATION

The present disclosure is a continuation of International Application No. PCT/CN2022/078937, filed Mar. 3, 2022, the entire content of which is incorporated herein by reference.

### TECHNICAL FIELD

The present disclosure relates to the movable detection technology field and, more particularly, to a control method, a movable platform, and a storage medium.

### BACKGROUND

To enable a movable platform to perform tasks safely and autonomously in an indoor environment. An indoor environment map needs to be constructed to facilitate subsequent path planning and decision-making. During a map construction process, the movable platform moves within the indoor environment and autonomously performs detection using a built-in detection device while moving. Based on detection data, the indoor environment map is constructed.

In existing technology, when constructing the indoor environment map, the movable platform often moves back and forth, which results in an overall long travel path, low efficiency, and poor user experience.

### SUMMARY

In accordance with the disclosure, there is provided a control method for a movable platform. The method includes obtaining a plurality of boundary points at a boundary of a detected region and an undetected region while a movable platform is moving indoors and performing detection on an indoor environment using a detection device, selecting a target boundary point from the plurality of boundary points according to feature information of the boundary points, and controlling the movable platform to move. For each of the boundary points, the feature information includes semantic information of at least a part of a region to be passed by the movable platform when moving from a current position to the boundary points.

Also in accordance with the disclosure, there is provided a movable platform, including a detection device, one or more processors, and one or more memories. The one or more memories store executable instructions that, when executed by the one or more processors, cause the movable platform to obtain a plurality of boundary points at a boundary of a detected region and an undetected region while the movable platform is moving indoors and performing detection on the indoor environment using the detection device, select a target boundary point from the plurality of boundary points according to the feature information of the boundary points, and control the movable platform to move. For each of the boundary points, the feature information includes semantic information of at least a part of a region to be passed by the movable platform when moving from a current position to the boundary points.

### BRIEF DESCRIPTION OF THE DRAWINGS

FIG. 1 is a schematic diagram showing a movable platform detecting an indoor environment consistent with an embodiment of the present disclosure.

FIG. 2 is a schematic flowchart of a control method of a movable platform consistent with an embodiment of the present disclosure.

FIG. 3 is a schematic flowchart showing a movable platform detecting an indoor environment consistent with an embodiment of the present disclosure.

FIG. 4 is a schematic diagram showing a detected region, a map, and boundary points consistent with an embodiment of the present disclosure.

FIG. 5 is a schematic structural diagram of a movable platform consistent with an embodiment of the present disclosure.

### DETAILED DESCRIPTION OF THE EMBODIMENTS

The technical solution of embodiments of the present disclosure is described in detail in connection with the accompanying drawings. Obviously, described embodiments are some embodiments of the present disclosure, not all embodiments. Based on embodiments of the present disclosure, all other embodiments obtained by those of ordinary skill in the art without creative efforts are within the scope of the present disclosure.

During the process of constructing an indoor environment map, a movable platform can move within the indoor environment and autonomously perform detection based on a built-in detection device. Based on detection data, the indoor environment map can be constructed in real-time. In the existing technology, when constructing the map of an indoor environment, the movable platform can often move back and forth, which results in an overall long movement path, low efficiency, and poor user experience.

Based on this, embodiments of the present disclosure provide a control method for the movable platform. The movable platform can include a detection device. The detection data of the detection device can be used to construct the indoor environment map. While the movable platform moves indoors and uses the detection device to perform detection on the indoor environment, a plurality of boundary points at a boundary of a detected region and an undetected region can be obtained. Then, based on feature information of the boundary points, a target boundary point can be selected from the plurality of boundary points. Thus, the movable platform can be guided to move to the target boundary point to detect the undetected region as much as possible. While selecting the target boundary point, the reference feature information can include semantic information of at least a part of a region that the movable platform passes by from the current position to the boundary point. Considering the environment structure and distribution of the indoor environment, the movable platform can enhance recognition of the indoor environment based on the semantic information, which is beneficial to improve the detection efficiency.

The control method of embodiments of the present disclosure can be executed by the movable platform. The movable platform can include, but is not limited to, a vacuum cleaner robot, a humanoid robot, a quadruped robot, an unmanned aerial vehicle (UAV), and an unmanned vehicle. The movable platform can include a detection device. The detection device can include, but is not limited to, a LiDAR, a millimeter-wave radar, an ultrasonic sensor, or a visual sensor. The detection data collected by the detection device can be used to construct an indoor environment map. The detection data collected by the detection device can also be used for other purposes. For example, image data collected by the visual sensor can be used to obtain semantic information in the indoor environment, such as furniture, doors, or corridors.

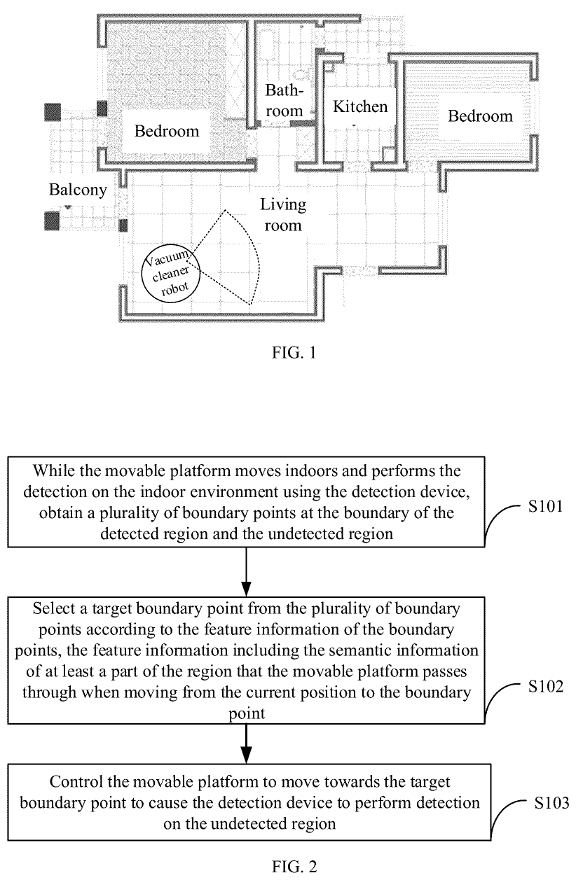

In some embodiments, for example, the movable platform can be a vacuum cleaner robot. As shown in FIG. 1, when the vacuum cleaner robot enters a new indoor environment, the vacuum cleaner robot performs detection on the indoor environment and constructs a map based on the control method of embodiments of the present disclosure to perform cleaning path planning on the indoor environment based on the constructed map during the process of cleaning the indoor environment subsequently. Thus, the indoor environment can be cleaned according to the planned cleaning path.

In some other embodiments, for example, the movable platform can be a UAV. When the UAV enters a new indoor environment, the UAV can perform detection on the indoor environment and construct a map based on the control method of embodiments of the present disclosure to plan a return path from the current position to the return point based on the map construction result subsequently when a user determines the return point. Thus, the autonomous return can be realized based on the return path.

In some embodiments, the types of the indoor environment may not be limited in the present disclosure and can include an indoor environment of an office, a home scenario, a mall, a warehouse, a restaurant, or an indoor activity court (e.g., a badminton court, a basketball court).

In some embodiments, FIG. 2 is a schematic flowchart of a control method of a movable platform consistent with an embodiment of the present disclosure. The method can be executed by the movable platform. The movable platform can include a detection device. The detection data of the detection device can be used to construct an indoor environment map. The method includes the following processes.

At S101, while the movable platform moves indoors and performs the detection on the indoor environment using the detection device, a plurality of boundary points at the boundary of the detected region and the undetected region (e.g., a boundary between the detected region and the undetected region) are obtained.

At S102, a target boundary point is selected from the plurality of boundary points according to the feature information of the boundary points. The feature information includes the semantic information of at least a part of the region that the movable platform passes through when moving from the current position to the boundary point.

At S103, the movable platform is controlled to move towards the target boundary point to cause the detection device to perform detection on the undetected region.

In some embodiments, during the process of performing the detection on the indoor environment using the detection device, the movable platform can be guided to move by selecting the target boundary point at the boundary of the detected region and the undetected region. Thus, the movable platform can move towards the undetected region as much as possible. In the process of selecting the target boundary point, the semantic information of at least a part of the region that the movable platform passes through when moving from the current position to the boundary point is taken into consideration. Thus, the environment structure and the distribution of the indoor environment can be considered during the movement of the movable platform. The recognition of the movable platform can be enhanced in the indoor environment based on the semantic information, which is beneficial to improve the detection efficiency.

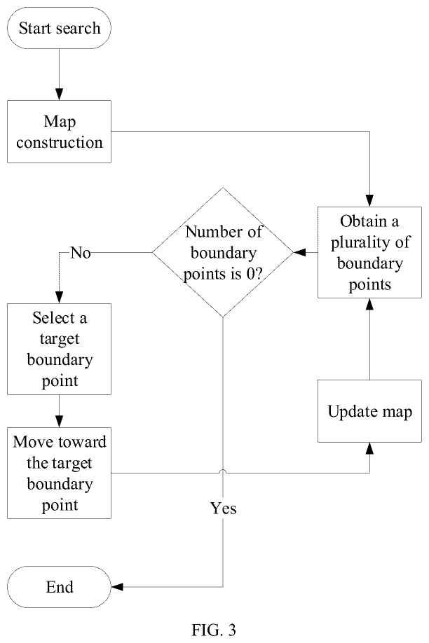

In some embodiments, while the movable platform performs the detection on the indoor environment using the detection device, the movable platform can construct the indoor environment map in real-time based on the detection data of the detection device. As shown in FIG. 3, when the movable platform starts to perform the detection on the indoor environment, the whole indoor environment is the undetected region. The movable platform can be in a certain position in the indoor environment, perform the detection on the surrounding environment using the carried detection device to obtain the detection data and construct the indoor environment map according to the detection data. Then, the plurality of boundary points at the boundary of the detected region and the undetected region can be obtained, and the target boundary point can be selected from the plurality of boundary points. Thus, the movable platform can be guided to move toward the target boundary point to perform the detection on the undetected region as much as possible using the detection device of the movable platform. The indoor environment map can be updated in real-time according to the detection data collected by the detection device during the detection process.

The movable platform can perform obstacle detection according to the detection data of the detection device to differentiate the detected region as an accessible area or an obstacle area according to the position information of the obstacle.

As shown in FIG. 3, when performing the detection on the indoor environment using the detection device, the movable platform repeats the following processes until the number of boundary points is zero (i.e., the detection on the indoor environment is complete). The processes include searching for the plurality of boundary points at the boundary of the detected region and the undetected region, selecting the target boundary point from the plurality of boundary points, controlling the movable platform to move toward the target boundary point, performing detection on the indoor environment using the detection device during movement, and updating the indoor environment map in real-time according to the detection data of the detection device.

In some embodiments, when the movable platform is moving, the boundary of the detected region and the undetected region can change continuously as the detection device continuously performs the detection on the indoor environment. The plurality of boundary points at the boundary of the detected region and the undetected region can be continuously updated. The process of obtaining the plurality of boundary points at the boundary of the detected region and the undetected region is described first below.

In some embodiments, the movable platform can identify locations of one or more boundaries between the detected region and the undetected region according to the indoor environment map that is constructed in real-time. Then, the plurality of boundary points can be generated at the boundaries according to the locations of one or more boundaries. For example, the plurality of boundary points can be generated at the boundaries at an equal distance, the plurality of boundary points can be generated at the boundaries randomly, or the plurality of boundary points can be generated at the boundaries according to a predetermined rule. For example, the distance between neighboring boundary points can be determined using arithmetic or geometric sequences.

In some other embodiments, a plurality of sampling points can be obtained by performing sampling randomly on the indoor environment. The indoor environment map can be constructed in real-time according to the plurality of sampling points. The plurality of boundary points at the boundary of the detected region and the undetected region can be obtained.

For example, since the indoor environment map stores relevant information about the detected region, whether the sampling point is at the boundary of the detected region and the undetected region can be determined according to the indoor environment map. If yes, the sampling point at the boundary can be determined as the boundary point.

For another example, the plurality of boundary points at the boundary of the detected region and the undetected region can be obtained by quickly searching a Random Tree (RT). First, a position point can be set as a root node. The position point can be the position, where the movable platform is currently at or a position in the detected region, which is not limited here. Thus, random sampling can be performed on the indoor environment to obtain the plurality of sampling points. For each sampling point, a node nearest to the sampling point can be determined in the tree structure. Then, along the direction of the nearest node and the sampling point, an extension node can be extended according to a preset step size. The extension node and a neighboring node can form an extension side. According to the real-time indoor environment map, whether the extension side crosses the detected region and the undetected region can be detected. If the extension side crosses the detected region and the undetected region, an endpoint of the extension side can be updated as a boundary point of the crossed area. Thus, the plurality of boundary point at the boundary of the detected region and the undetected region can be obtained.

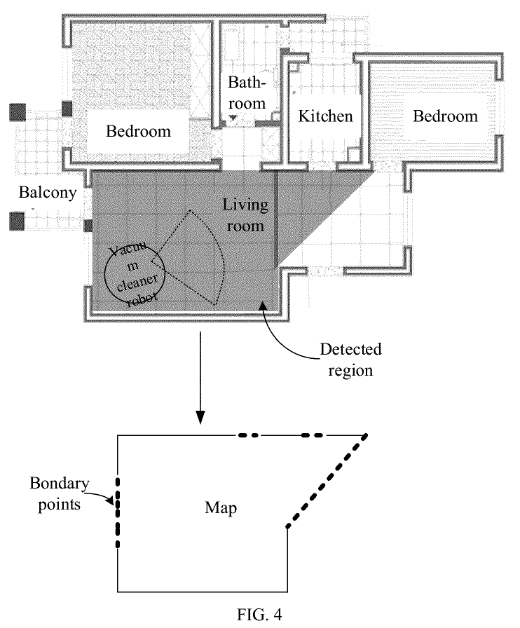

In some embodiments, as shown in FIG. 4, after the movable platform performs the detection on the indoor environment of FIG. 1, the indoor environment map constructed or updated based on the detectable area and the plurality of boundary points at the boundary of the detected region and the undetected region are shown. As shown in FIG. 4, the movable platform can perform obstacle detection according to the detection data of the detection device to differentiate the detected region as the accessible area (blank area in the map) or the obstacle area (solid line area in the map) according to the position information of the obstacle.

In some embodiments, after obtaining the plurality of boundary points at the boundary of the detected region and the undetected region, the movable platform can select the target boundary point from the plurality of boundary points according to the feature information of the boundary points to guide the movable platform to move to enable the detection device to perform detection the undetected region. The feature information can include the semantic information of at least a part of the region that the movable platform passes through when moving from the current position to the boundary point. Then, the movement of the movable platform can take the environment structure and the distribution of the indoor environment into consideration. Based on the semantic information, the recognition of the movable platform on the indoor environment can be enhanced, which is beneficial to improve the detection efficiency.

In some embodiments, the movable platform can be provided with the visual sensor. When the movable platform is moving indoors, the movable platform can obtain image data collected by the visual sensor and obtain semantic information about the indoor environment based on the image data.

In some embodiments, after obtaining the plurality of boundary points, the movable platform can plan the movement path from the current position to the boundary points. Then, based on the movement path and the semantic information of the indoor environment, the semantic information of at least a part of the region that the movable platform passes through when moving from the current position to the boundary points. For example, the plurality of boundary points can include boundary point 1, boundary point 2, and boundary point 3. The movable platform can plan movement path 1 when the movable platform moves from the current position to boundary point 1, movement path 2 when the movable platform moves from the current position to boundary point 2, and movement path 3 when the movable platform moves from the current position to boundary point 3. Based on movement path 1, movement path 2, movement path 3, and the semantic information of the indoor environment, the semantic information of at least a part of the region that the movable platform passes through when moving from the current position to the boundary point 1, the semantic information of the at least a part of the region that the movable platform passes through when moving from the current position to the boundary point 2, and the semantic information of the at least a part of the region that the movable platform passes through when moving from the current position to the boundary point 3 can be obtained.

In some embodiments, according to the current position of the movable platform, the positions of the boundary points, and the map indoor environment that is real-time constructed, the movement path of the movable platform from the current position to the boundary points can be planned. The accessibility can also be taken into consideration when the movement path is planned.

In some embodiments, the image data can be processed through semantic segmentation or instance segmentation to obtain the semantic information of the indoor environment. For example, the semantic information can include, but is not limited to, information about furniture, doors, corridors, or room types.

In some embodiments, the semantic information can include furniture and/or doors. Furniture can refer to essential facilities for maintaining normal life, conducting production practices, and carrying out social activities. For example, in the indoor environment of a residential place, the furniture can include but is not limited to sofas, tables, wardrobes, chairs, or beds. In the indoor environment of an office place, the furniture can include but is not limited to office desks, office chairs, or computer equipment. The door can indicate an entrance and exit leading from one room to another or from a functional area to another.

To reduce or avoid the movable platform moving back and forth between a plurality of rooms, the movable platform can first select a target boundary point from the plurality of boundary points where the movement to the point does not require moving from one room to another. Thus, the movable platform can complete the detection of one room before moving to the next room to avoid the situation in which the movable platform needs to subsequently perform the detection on the room that is not finished with the detection when the movable platform is at another room without finishing the detection on the current room. Thus, the detection efficiency of the movable platform can be improved.

For example, the movable platform can determine the movement paths of the movable platform moving to each boundary point of the plurality of boundary points. Then, whether the movement paths corresponding to the boundary points pass through the furniture and/or door can be determined. If a movement path passes through the furniture but does not pass through the door, the detection of the room where the movable platform is currently in is not finished. Then, the boundary points with which the movement path passes through the furniture but does not pass through the door can be selected as the target boundary points to cause the movable platform to continue to perform the detection on the current room. If the movement paths corresponding to the boundary points pass through the door, the detection of the current room can be completed. Then, the movable platform can move to the next room or other areas to perform detection. In some embodiments, the recognition of the movable platform in the indoor environment can be enhanced based on the semantic information, which is beneficial to reduce or avoid the movable platform moving back and forth between different rooms to further improve the detection efficiency.

In some embodiments, the semantic information can include corridors. A corridor can be a connection passage between at least two rooms (or different functional areas). To avoid or reduce the movable platform from moving back-and-forth in the corridor, during the selection of target boundary points, the movable platform can first select a boundary point from the plurality of boundary points as the target boundary point with which the movable platform does not need to move from one side of the corridor to the other side of the corridor when moving to the boundary point. Thus, the situation that the movable platform needs to subsequently return to the side of the corridor that is not finished with the detection for further detection because the movable platform moves to the other side of the corridor without finishing the detection of the side of the corridor. Therefore, the detection efficiency of the movable platform can be improved.

For example, during the process of moving to each boundary point of the plurality of boundary points, the movable platform can determine whether the movable platform need to move to the other side of the corridor from the current side of the corridor. If a boundary point with which the movable platform does not need to move to the other side from the current side of the corridor exists, the detection of the current side of the corridor may not be completed. Then, the boundary point with which the movable platform does not need to move from the current side to the other side can be used as the target boundary point to enable the movable platform to continue to perform detection on the current side of the corridor. If the plurality of boundary points are the boundary points with which the movable platform needs to move to the other side from the current side of the corridor, the detection of the current side of the corridor can be completed. Thus, the movable platform can move to the other side of the corridor for detection. In embodiments of the present disclosure, the recognition of the movable platform for the indoor environment can be enhanced based on the semantic information, which is beneficial to reduce the back-and-forth movement of the movable platform between the two sides of the corridor. Thus, the detection efficiency can be improved.

For example, after the movable platform finishes the detection of a room and leaves the room, if the movable platform is located in another room, the boundary point in the other room can be first selected as the target boundary point to enable the movable platform to complete the detection of the current room. After the movable platform leaves the room in which the detection is completed, the movable platform can be in the corridor. Then, the boundary point with which the movable platform does not need to pass through the corridor to reach the other side of the corridor can be first selected as the target boundary point. Thus, the movable platform can complete the detection at the current side of the corridor, which reduces the back-and-forth movement of the movable platform to improve detection efficiency.

In some embodiments, the semantic information can include room types. Different room types can indicate different functions of the room. For example, in the indoor environment of the residential place, the room type can include but is not limited to bedrooms, living rooms, dining rooms, bathrooms, or study rooms. In the indoor environment of the office place, the room type can include but is not limited to offices, meeting rooms, break rooms, bathrooms, or reception areas.

During the selection of the target boundary point, the movable platform can first select the boundary point with which the movable platform passes through the room of the predetermined type as the target boundary point when the movable platform moves to the boundary point to enable the movable platform to first complete the detection of the room of the predetermined type.

Different detection sequences of a plurality of rooms of different room types can be set according to different needs of the indoor environment, which are not limited in embodiments of the present disclosure.

For example, the detection sequence of the movable platform can be determined based on the cleanliness level of rooms of different room types. A cleaner room can have a detection sequence in the front, which avoids or reduces dirt from other rooms being brought to the clean room when the movable platform performs the detection. For example, for bedrooms, living rooms, dining rooms, bathrooms, or study rooms, the detection sequences of different rooms can be determined according to the cleanliness levels corresponding to the plurality of rooms of different room types. Assume that the bedroom is the cleanest, the cleanliness level can be the highest. The sequence according to the cleanliness degrees can be bedrooms to study rooms to living rooms to dining rooms to the bathrooms. Thus, during the selection of the target boundary point, the movable platform can detect the room type of the room that the movable platform passes through when the movable platform moves to the boundary points. The boundary point with which the movable platform passes through the bedroom can be used as the target boundary point. After the detection of the bedroom, the boundary point with which the movable platform passes through the study room can be used as the target boundary point, and so on. The movable platform can perform the detection on different rooms according to the cleanliness levels of the rooms of the different room types, which is beneficial to ensure the cleanliness degrees of the rooms. The dirt of other rooms can be prevented from being brought to the clean room during the movement of the movable platform.

For example, the detection sequence can also be determined according to the usage frequency of the rooms of different types. For example, a room with a low usage frequency can have a detection sequence at the front. For example, in the indoor environment of the office place, an office and a meeting room can be provided. Since the usage frequency of the meeting room is usually lower than the usage frequency of the office, the sequence can be arranged according to the usage frequencies, from the meeting room to the office in sequence. Then, during the selection of the target boundary point, the movable platform can determine the movement paths of the boundary point of the plurality of boundary points and detect the room types of the room passed by the movement paths corresponding to the boundary points. The boundary point with which the movable platform passes through the meeting room can be used as the target boundary point. After finishing the detection in the meeting room, the boundary point with which the movable platform passes the office can be used as the target boundary point. The movable platform can perform detection on different rooms according to the usage frequencies of the rooms of different room types.

In some embodiments, in addition to the semantic information, the feature information of the boundary points can include one or more of an area of the undetected region that is detectable when the movable platform is at the boundary point, a distance between the movable platform and the boundary point, or a boundary point density around the boundary point. The undetected region that is detectable when the movable platform is at the boundary point is also referred to as a “detectable undetected region” or a “detectable region.” During the selection, by the movable platform, of the target boundary point, at least one of the above three can be taken into consideration in addition to the semantic information.

For the area of the undetected region, the movable platform can determine the detectable region corresponding to the boundary point according to the detection range of the detection device and the position information of the boundary point. For example, the position of the boundary point can be considered as the detection center of the detection device at the boundary point. In combination with the detection range of the detection device, the detectable region corresponding to the boundary point can be determined to further determine that the area of the undetected region can include the difference between the area of the detectable region and the area of the detected region in the detectable region.

The distance between the movable platform and the boundary point can be calculated according to the position information of the movable platform and the position information of the boundary point.

The boundary point density around the boundary point can be determined according to the number of other boundary points within a boundary point predetermined range.

In some embodiments, when the semantic information is satisfied, according to the area of the undetected region that is detectable when the movable platform is at the boundary point, the boundary point with which the area of the undetected region that is detectable is larger can be used as the target boundary point. According to the distance between the movable platform and the boundary point, the movable platform can first select the boundary point with a shorter distance to the movable platform as the target boundary point. According to the boundary point density around the boundary point, the movable platform can first select the boundary point with a higher density as the target boundary point. While reducing the back-and-forth movement of the movable platform of embodiments of the present disclosure, the moving cost of the movable platform can be further reduced (the distance is shorter, and the movement cost is lower) or increases the detection gain (the detection gain is larger when the area of the undetected region that is detectable is larger of the density is higher).

For example, the semantic information can include furniture and/or doors. The movable platform can determine whether the movable platform passes through the furniture and/or the door when moving to the boundary points of the plurality of boundary points according to the position information and/or the position information of the furniture. If at least two selectable boundary points with which the movable platform can pass through the furniture but not pass through the door exist, the boundary point with which the area of the undetected region that is detectable is larger, the distance is shorter, and/or the density is higher can be used as the target boundary point to detect another room with a lower path cost, and/or more detection gain.

For another example, if the semantic information includes a corridor, the movable platform can determine whether the movable platform needs to move from the current side to the other side when moving to the boundary points according to the position information of the corridor. If at least two selectable boundary points with which the movable platform does not need to move from the current side to the other side exist, the movable platform can first select the boundary points with the larger area of the undetected region that is detectable, the shorter distance, and/or the higher density as the target boundary points. Thus, the current side of the corridor can be detected with fewer path cost and/or more detection gain.

In some embodiments, an evaluation model can be determined according to the at least two selection requirements of the above selected target boundary points. The evaluation model can be configured to comprehensively evaluate the at least two pieces of feature information of the boundary points. The movable platform can select the target boundary point from the plurality of boundary points according to the feature information of the boundary points and the predetermined evaluation model. For example, the movable platform can input the at least two pieces of feature information of the boundary points into the predetermined evaluation model to enable the predetermined evaluation model to comprehensively evaluate the at least two pieces of feature information of the boundary points to obtain an evaluation score. For example, each piece of feature information can correspond to an evaluation score. A total evaluation score can be a sum of the evaluation score corresponding to each piece of feature information. The total evaluation score can be used to determine the target boundary points.

For example, if the movable platform does not need to pass through the door when moving to the boundary point, the corresponding evaluation score can be higher. If the movable platform does not need to move from one side of the corridor to the other side of the corridor when moving to the boundary point, the corresponding evaluation score can be higher. If the detected area of the undetected region is larger, the distance is shorter, and/or the density is higher, the corresponding evaluation score can be higher. Then, the boundary point with the highest total evaluation score can be used as the target boundary point. The evaluation model can obtain the evaluation score of the boundary point by comprehensively evaluating at least two pieces of feature information of the boundary point based on the above rule. Thus, the movable platform can select the target boundary point with the highest score based on the evaluation scores to improve the detection efficiency of the movable platform in the indoor environment.

For example, the evaluation score corresponding to each piece of feature information can correspond to a weight. Thus, when a plurality of pieces of feature information are considered comprehensively, the contribution to the selection result can be assigned to each piece of feature information.

In some embodiments, the timing for updating the target boundary point can be set according to the actual application scenario. In some embodiments, after detecting the previous target boundary point, the movable platform can select a new target boundary point from the plurality of boundary points based on the feature information of the boundary points. Then, the movable platform can be controlled to move according to the position information of the new target boundary point. In some other embodiments, without waiting for the movable platform to detect the previous target boundary point, the movable platform can select a new target boundary point from the plurality of boundary points at a preset update frequency according to the feature information of the boundary points. Then, the movable platform can be controlled to move according to the position information of the new target boundary point. The preset update frequency can be set according to the actual application scenario. For example, the new target boundary point can be updated 20 times per second. The plurality of boundary points at the boundary at the detected region and the undetected region can be updated in real-time according to the detection process of the detection device.

In some embodiments, after selecting the target feature point, the movable platform can be controlled to move towards the target boundary point. For example, the movable platform can obtain the movement path to the target boundary point. Then, the movable platform can be controlled to move along the movement path to the target boundary point until the target boundary point is detected or the new target boundary point is determined during the movement. During the movement of the movable platform, the detection device can perform the detection on the indoor environment in real-time. Then, the movable platform can update the indoor environment map in real-time based on the detection data of the detection device. When the boundary point is not obtained, the undetected region may not exist in the indoor environment. The detection of the indoor environment can be completed, and the indoor environment map can be constructed.

After the indoor environment map is constructed, the movable platform can perform path planning and decision according to the indoor environment map. For example, the movable platform can be a vacuum cleaner robot. After the indoor environment map is constructed, the movable platform can respond to a cleaning instruction to determine a cleaning sequence of the plurality of rooms according to the indoor environment map and the room types of the rooms in the indoor environment and clean the rooms of the plurality of rooms according to the cleaning sequence.

The technical features above can be combined arbitrarily, as long as there is no conflict or contradiction in the combination of the features. Thus, the arbitrary combination of the technical features is also in the scope of the present disclosure.

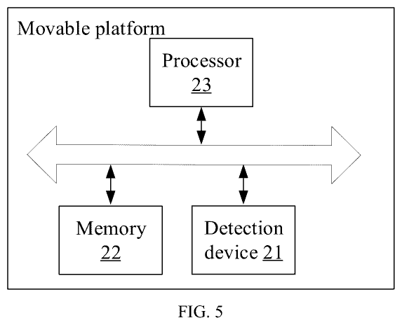

As shown in FIG. 5, embodiments of the present disclosure further provide a movable platform including a detection device 21, one or more memories 22, and one or more processors 23.

The detection data of the detection device 21 can be used to construct the indoor environment map.

The one or more memories 22 can be used to store executable instructions.

The one or more processors 23 can be configured to, when execute the executable instructions individually or together, obtain the plurality of boundary points of the boundary of the detected region and the undetected region when the movable platform is moving indoors and performing the detection on the indoor environment using the detection device, select the target boundary point from the plurality of boundary points according to the feature information of the boundary points, the feature information including the semantic information of at least a part of region to be passed by the movable platform when moving from the current position to the boundary point, and control the movable platform to the target boundary point to enable the detection device to perform the detection on the undetected region.

The detection device 21 can include, but is not limited to, a LiDAR, a microwave radar, an ultrasound sensor, or a visual sensor.

The one or more processors 23 can execute the executable instructions stored in the one or more memories 22. The one or more processors 23 can include central processing units (CPUs), other general-purpose processors, digital signal processors (DSPs), application specific integrated circuits (ASICs), field-programmable gate arrays (FPGAs), or other programmable logic devices, discrete gates, or transistor logic devices, discrete hardware assemblies, etc. The general-purpose processor can include a microprocessor or any conventional processor.

The one or more memories 22 can store the executable instructions for the control method. The one or more memories 22 can include at least one type of storage medium. The storage medium can include a flash memory, a hard drive, a multimedia card, a card-type storage (e.g., SD or DX storage), a random access memory (RAM), a static random access memory (SRAM), a read-only memory (ROM), an electrically erasable programmable read-only memory (EEPROM), a programmable read-only memory (PROM), a magnetic storage, magnetic disks, optical disks, etc. Moreover, the movable platform can cooperate with network storage devices that execute storage functions through network connections. The one or more memories 22 can be an internal storage unit of the movable platform, such as a hard drive or memory of the movable platform or an external storage of the movable platform, such as a plug-in hard drive, a smart media card (SMC), a secure digital (SD) card, a flash card, etc. Furthermore, the one or more memories (22) can include the internal storage unit and the external storage of the movable platform. The one or more memories 22 can be used to store the executable instructions and other programs and data required by the movable platform. The one or more memories 22 can also be used to temporarily store the data that is output or is about to be output.

In some embodiments, the semantic information can include the furniture and/or door. The one or more processors can be further configured to first select the boundary point with which the movable platform does not need to move from one room to another room when moving to the boundary point as the target boundary point to cause the movable platform to complete the detection of one room before moving to a next room.

In some embodiments, the semantic information can include the corridor. The one or more processors can be further configured to first select the boundary point with which the movable platform does not need to move from one side of the corridor to the other side of the corridor when moving to the boundary point as the target boundary point to cause the movable platform to first complete the detection of the one side of the corridor before moving to the other side of the corridor.

In some embodiments, the semantic information can include the room type. The one or more processors can be further configured to first select the boundary point with which the movable platform passes through the room of the predetermined room type when moving to the boundary point as the target boundary point to cause the movable platform to first complete the detection for the room with the predetermined room type. The room with the predetermined room type may have a better cleanliness level or lower usage frequency.

In some embodiments, the detection device can include a LIDAR, and the movable platform can also include a vision sensor. The one or more processors can be further configured to obtain the semantic information of the indoor environment according to the image data of the vision sensor when the movable platform is moving indoors.

In some embodiments, the one or more processors can be further configured to plan the movement paths of the movable platform from the current position to the boundary points and obtain the semantic information of at least a part of the region to be passed by the movable platform when moving from the current position to the boundary points according to the movement paths and the semantic information of the indoor environment.

In some embodiments, the feature information can further include one or more of the area of the undetected region that is detectable when the movable platform is at the boundary point, the distance between the movable platform and the boundary point, or the boundary point density around the boundary point.

In some embodiments, the area of the undetected region can include the difference between the area of the detectable region corresponding to the boundary point and the area of the undetected region within the detectable region. The detectable region corresponding to the boundary point can be determined based on the detection range of the detection device and the position information of the boundary point.

In some embodiments, the one or more processors can be further configured to first select the boundary point with which the area of the undetected region that is detectable is larger than the target boundary point, and/or the boundary point with which the distance is shorter as the target boundary point, and/or the boundary point with which the density is higher as the target boundary point.

In some embodiments, the one or more processors can be further configured to select the target boundary point from the plurality of boundary points according to the feature information of the boundary points and the preset evaluation model. The evaluation model can be configured to comprehensively evaluate the feature information.

In some embodiments, the one or more processors can be further configured to obtain the movement path of the movable platform to the target boundary point, control the movable platform to move along the movement path to the target boundary point until the target boundary point is detected or a new target boundary point is determined during the movement.

In some embodiments, the one or more processors can be further configured to, after the movable platform detects the previous target boundary point, select the target boundary point from the plurality of boundary points according to the feature information of the boundary points or select the target boundary point from the plurality of boundary points according to the feature information of the boundary points at the preset update frequency.

In some embodiments, the one or more processors can be further configured to construct the indoor environment map in real-time according to the detection data of the detection device.

In some embodiments, the one or more processors can be further configured to identify one or more boundary positions between the detected region and the undetected region according to the indoor environment map and generate the plurality of boundary points at the boundary according to the one or more boundary positions.

In some embodiments, the one or more processors can be further configured to perform random sampling on the indoor environment to obtain a plurality of sampling points and obtain the plurality of boundary points at the boundary of the detected region and the undetected region according to the plurality of sampling points and the indoor environment map.

In some embodiments, the movable platform can include a vacuum cleaner robot. The one or more processors can be further configured to, after the indoor environment map is constructed, respond to a cleaning instruction, determine the cleaning sequence of a plurality of rooms according to the indoor environment map and the room types of the rooms in the indoor environment, and sequentially clean each room of the plurality of rooms according to the cleaning sequence.

In some embodiments, the movable platform can include one or more of a vacuum cleaner robot, a movable robot, an autonomous vehicle, or an unmanned aerial vehicle.

Embodiments described here can be implemented using a computer-readable medium, such as computer software, hardware, or a combination thereof. For hardware implementations, embodiments described here can be implemented using at least one of an application-specific integrated circuit (ASIC), a digital signal processor (DSP), a digital signal processing device (DSPD), a programmable logic device (PLD), a field-programmable gate array (FPGA), a processor, a controller, a microcontroller, a microprocessor, or an electronic unit designed to perform the described functions. For software implementations, process or functional embodiments can be implemented by an individual software module for executing at least one function or operation. Software codes can be implemented by a software application (or program) written in any suitable programming language and can be stored in the memory and executed by the controller.

For the implementation of the functions and effects of the units of the movable platform, reference can be made to the implementation of the corresponding steps of the method, which is not repeated here.

Embodiments of the present disclosure further provide a non-transitory computer-readable storage medium including the instructions, for example, a memory including the instructions. The instructions can be executed by the processor of the device to complete the above method. For example, the non-transitory computer-readable storage medium can include a ROM, a RAM, a CD-ROM, a cassette, a floppy disk, and a data storage device.

A non-transitory computer-readable storage medium storing the instructions that, when executed by a processor of a terminal, cause the terminal to perform the above method.

In some embodiments, the relationship terms such as first and second can be merely used to distinguish one entity or operation from another, and do not necessarily imply any actual relationship or order between such entities or operations. The terms “comprising,” “comprising,” or any other variations thereof are intended to cover a non-exclusive inclusion, such that a process, method, article, or apparatus that includes a series of elements not only include those elements but also includes other elements not expressly listed or inherent to such process, method, article, or apparatus. When there is no further limitation, an element defined by the phrase “including a . . . ” does not exclude another identical element in the process, method, article, or apparatus that includes the element.

The method and device of embodiments of the present disclosure are described in detail above. Some examples are used to illustrate the principles and implementations of the present disclosure. The description of embodiments of the present disclosure is only intended to assist in understanding the method and the core idea of the present disclosure. Meanwhile, for those ordinary skills in the art, changes can be made to the implementations and application scopes according to the ideas of the present disclosure. Therefore, the content of the specification should not be considered to limit the present disclosure.

What is claimed is:

1. A control method comprising:
obtaining a plurality of boundary points at a boundary of a detected region and an undetected region while a movable platform is moving indoors and performing detection on an indoor environment using a detection device;
selecting a target boundary point from the plurality of boundary points according to feature information of the boundary points, for each of the boundary points, the feature information including semantic information of at least a part of a region to be passed by the movable platform when moving from a current position to the boundary point; and
controlling the movable platform to move to the target boundary point.

2. The method according to claim 1, wherein:
the semantic information includes at least one of furniture or a door; and
selecting the target boundary point includes:
selecting, as the target boundary point, one of the boundary points with which the movable platform does not need to enter another room when moving to the one of the boundary points.

3. The method according to claim 1, wherein:
the semantic information includes a corridor; and
selecting the target boundary point includes:
selecting, as the target boundary point, one of the boundary points with which the movable platform does not need to move from one side of the corridor to another side of the corridor when moving to the one of the boundary points.

4. The method according to claim 1, wherein:
the semantic information includes a room type; and
selecting the target boundary point includes:
selecting, as the target boundary point, one of the boundary points with which the movable platform passes through a room with a predetermined room type when moving to the one of the boundary points.

5. The method according to claim 1, further comprising:
planning movement paths of the movable platform moving from the current position to the boundary points; and
obtaining the semantic information of each of the boundary points according to the movement path to the boundary point and semantic information of the indoor environment.

6. The method according to claim 1, wherein the feature information of each of the boundary points further includes at least one of an area of a detectable region that is part of the undetected region but detectable when the movable platform is at the boundary point, a distance between the current position of the movable platform and the boundary point, or a boundary point density around the boundary point.

7. The method according to claim 6, wherein selecting the target boundary point includes at least one of:
selecting, as the target boundary point, one of the boundary points with which the area of the detectable region is largest among the boundary points;
selecting, as the target boundary point, one of the boundary points with which the distance is shortest among the boundary points; or
selecting, as the target boundary point, one of the boundary points with which the boundary point density is highest among the boundary points.

8. The method according to claim 1, wherein controlling the movable platform to move to the target boundary point includes:
obtaining a movement path of the movable platform moving to the target boundary point; and
controlling the movable platform to move to the target boundary point according to the movement path until the target boundary point is detected or a new target boundary point is determined during movement.

9. The method according to claim 1, wherein selecting the target boundary point includes:
after the movable platform detects a previous target boundary point, selecting the target boundary point from the plurality of boundary points according to the feature information of the boundary points; or
selecting the target boundary point from the plurality of boundary points according to the feature information of the boundary points at a preset update frequency.

10. The method according to claim 1, further comprising:
constructing an indoor environment map in real-time according to detection data of the detection device.

11. The method according to claim 10, wherein obtaining the plurality of boundary points includes:
identifying positions of one or more boundaries between the detected region and the undetected region according to the indoor environment map; and
generating the plurality of boundary points according to the positions of the one or more boundaries.

12. The method according to claim 10, wherein obtaining the plurality of boundary points includes:
performing random sampling on the indoor environment to obtain a plurality of sampling points; and
obtaining the plurality of boundary points according to the plurality of sampling points and the indoor environment map.

13. The method according to claim 1,
wherein the movable platform is a vacuum cleaner robot;
the method further comprising, after constructing an indoor environment map:
responding to a cleaning instruction, determining a cleaning sequence of a plurality of rooms according to the indoor environment map and room types of the rooms in the indoor environment; and
cleaning the plurality of rooms according to the cleaning sequence.

14. A movable platform comprising:
a detection device;
one or more processors; and
one or more memories storing executable instructions that, when executed by the one or more processors, cause the movable platform to:
obtain a plurality of boundary points at a boundary of a detected region and an undetected region while the movable platform is moving indoors and performing detection on the indoor environment using the detection device;
select a target boundary point from the plurality of boundary points according to the feature information of the boundary points, for each of the boundary points, the feature information including semantic information of at least a part of a region to be passed by the movable platform when moving from a current position to the boundary points; and
control the movable platform to move toward the target boundary point.

15. The movable platform according to claim 14, wherein:
the semantic information includes at least one of furniture or a door; and
the one or more processors are further configured to:
select, as the target boundary point, one of the boundary points with which the movable platform does not need to enter another room when moving to the one of the boundary points.

16. The movable platform according to claim 14, wherein:
the semantic information includes a corridor; and
the one or more processors are further configured to:
select, as the target boundary point, one of the boundary points with which the movable platform does not need to move from one side of the corridor to another side of the corridor when moving to the one of the boundary points.

17. The movable platform according to claim 14, wherein the feature information of each of the boundary points further includes at least one of an area of a detectable region that is part of the undetected region but detectable when the movable platform is at the boundary point, a distance between the current position of the movable platform and the boundary point, or a boundary point density around the boundary point.

18. The movable platform according to claim 14, wherein the one or more processors are further configured to at least one of:
select, as the target boundary point, one of the boundary points with which the area of the detectable region is largest among the boundary points;
select, at the target boundary point, one of the boundary points with which the distance is shortest among the boundary points; or
select, as the target boundary point, one of the boundary points with which the boundary point density is highest among the boundary points.

19. The movable platform according to claim 14, wherein the one or more processors are further configured to:
obtain a movement path of the movable platform moving to the target boundary point; and
control the movable platform to move to the target boundary point according to the movement path until the target boundary point is detected or a new target boundary point is determined during movement.

20. The movable platform according to claim 14, wherein the one or more processors are further configured to:
after the movable platform detects a previous target boundary point, select the target boundary point from the plurality of boundary points according to the feature information of the boundary points; or
select the target boundary point from the plurality of boundary points according to the feature information of the boundary points at a preset update frequency.
